(19) United States
(12) Patent Application Publication
(10) Pub. No.: US 2025/0322992 A1
(43) Pub. Date: Oct. 16, 2025

(54) MULTILAYER CERAMIC CAPACITOR

(71) Applicant: Murata Manufacturing Co., Ltd., Nagaokakyo-shi (JP)

(72) Inventor: Tatsunori YASUDA, Nagaokakyo-shi (JP)

(21) Appl. No.: 19/252,430

(22) Filed: Jun. 27, 2025

Related U.S. Application Data
(63) Continuation of application No. PCT/JP2024/026253, filed on Jul. 23, 2024.

(30) Foreign Application Priority Data
Aug. 29, 2023 (JP) 2023-139286

(51) Int. Cl. H01G 4/012; H01G 2/06; H01G 4/12; H01G 4/30

(52) U.S. Cl. CPC H01G 4/012; H01G 2/065; H01G 4/12; H01G 4/30

(57) ABSTRACT

A multilayer ceramic capacitor includes dielectric layers and internal electrode layers laminated in a lamination direction, and first and second lateral surfaces opposed to each other in a width direction. A distance between an end portion, closest to the first lateral surface among end portions of the internal electrode layers adjacent to the first lateral surface, and the first lateral surface is smaller than a distance between an end portion, closest to the second lateral surface among end portions of the internal electrode layers adjacent to the second lateral surface, and the second lateral surface. A maximum distance in the width direction between end portions of the internal electrode layers adjacent to the first lateral surface in the width direction is smaller than a maximum distance in the width direction between end portions of the internal electrode layers adjacent to the second lateral surface in the width direction.

### CROSS REFERENCE TO RELATED APPLICATIONS

This application claims the benefit of priority to Japanese Patent Application No. 2023-139286 filed on Aug. 29, 2023 and is a Continuation Application of PCT Application No. PCT/JP2024/026253 filed on Jul. 23, 2024. The entire contents of each application are hereby incorporated herein by reference.

### BACKGROUND OF THE INVENTION

### 1. Field of the Invention

The present invention relates to multilayer ceramic capacitors.

### 2. Description of the Related Art

In the prior art, multilayer ceramic capacitors, which are widely used in various electronic devices such as mobile terminal devices including mobile phones or personal computers, each include a rectangular parallelepiped-shaped multilayer body including an inner layer portion in which dielectric layers and internal electrode layers are alternately laminated, and outer layer portions provided respectively on the upper and lower portions of the inner layer portion, and external electrodes provided on both end surfaces in the longitudinal direction of such a multilayer body. In such multilayer ceramic capacitors, a further reduction in size and increase in capacitance are required together with the development of electronic devices in recent years.

On the other hand, multilayer ceramic capacitors are likely to generate vibration sounds, called “acoustic noise”, when mounted on a substrate, and in order to reduce or prevent the generation of “acoustic noise”, a multilayer ceramic capacitor has been known which includes a spacer that covers a portion of the external electrode on the side where the multilayer ceramic capacitor is mounted on the substrate (for example, refer to Japanese Unexamined Patent Application, Publication No. 2015-216337).

However, the multilayer ceramic capacitor with a spacer has room for improvement with respect to the cost of placing the spacer and the accuracy when placing the spacer.

### SUMMARY OF THE INVENTION

Example embodiments of the present invention provide multilayer ceramic capacitors that are each able to reduce or prevent the generation of “acoustic noise”, while reducing the size and increasing the capacitance.

The inventor of example embodiments of the present invention has discovered that, by adjusting the positioning of each of the end portions provided along one lateral surface and the positioning of each of the end portions provided along the other lateral surface, among a plurality of end portions in the width direction of internal electrode layers provided along two opposed lateral surfaces of the multilayer body, it is possible to reduce or prevent the generation of “acoustic noise” of the multilayer ceramic capacitor while reducing the size and increasing the capacitance.

An example embodiment of the present invention provides a multilayer ceramic capacitor that includes a multilayer body with a rectangular or substantially rectangular parallelepiped shape including a plurality of dielectric layers and a plurality of internal electrode layers that are alternately laminated in a lamination direction, a first main surface and a second main surface opposed to each other in the lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction, and a pair of external electrodes each provided at an end in the length direction of the multilayer body so as to cover at least the first end surface and the second end surface, respectively, and each connected to the internal electrode layers, in which a distance between an end portion, which is closest to the first lateral surface among end portions of the plurality of internal electrode layers adjacent to the first lateral surface in the width direction, and the first lateral surface is smaller than a distance between an end portion, which is closest to the second lateral surface among end portions of the plurality of internal electrode layers adjacent to the second lateral surface in the width direction, and the second lateral surface, and a maximum distance in the width direction between the end portions of the plurality of internal electrode layers adjacent to the first lateral surface in the width direction is smaller than a maximum distance in the width direction between the end portions of the plurality of internal electrode layers adjacent to the second lateral surface in the width direction.

According to example embodiments of the present invention, it is possible to reduce the size and increase the capacitance of a multilayer ceramic capacitor, while reducing or preventing an occurrence of “acoustic noise”.

The above and other elements, features, steps, characteristics and advantages of the present invention will become more apparent from the following detailed description of the example embodiments with reference to the attached drawings.

### BRIEF DESCRIPTION OF THE DRAWINGS

FIG. 1 is a perspective view showing a multilayer ceramic capacitor according to an example embodiment of the present invention.

FIG. 2 is a cross-sectional view along the line II-II of the multilayer ceramic capacitor shown in FIG. 1 (LT cross-section).

FIG. 3 is a cross-sectional view along the line III-III of the multilayer ceramic capacitor shown in FIG. 1 (WT cross-section).

FIG. 4 is a cross-sectional view showing a state in which the multilayer ceramic capacitor shown in FIG. 1 is mounted (WT cross-section).

FIG. 5 is an enlarged view of an end portion of internal electrode layers of the multilayer ceramic capacitor shown in FIG. 4.

FIG. 6 is a perspective view showing a multilayer body chip which is a precursor of a multilayer body of the multilayer ceramic capacitor shown in FIG. 1.

FIG. 7 is a view showing a state in which a lateral surface covering portion is attached to the multilayer body chip shown in FIG. 6.

### DETAILED DESCRIPTION OF THE EXAMPLE EMBODIMENTS

The following describes example embodiments of multilayer ceramic capacitors according to the present invention, but the present invention is not limited thereto. The drawings may be schematically simplified to explain the contents of example embodiments of the present invention, and the ratio of dimensions of the components or between components depicted in the drawings may not match the ratio of dimensions described in the specification. Also, components described in the specification may be omitted in the drawings, or the number of components may be reduced in the drawings.

### Multilayer Ceramic Capacitor

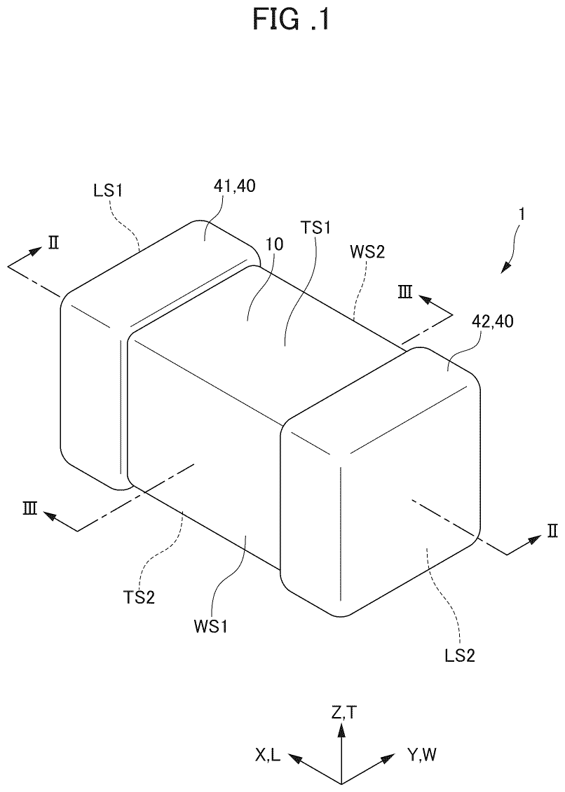

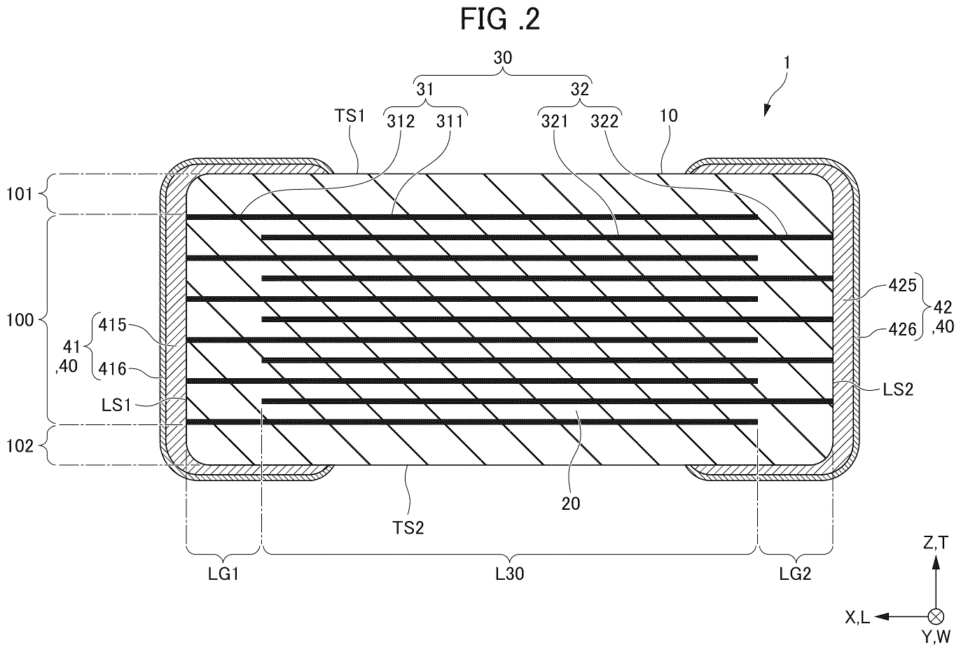

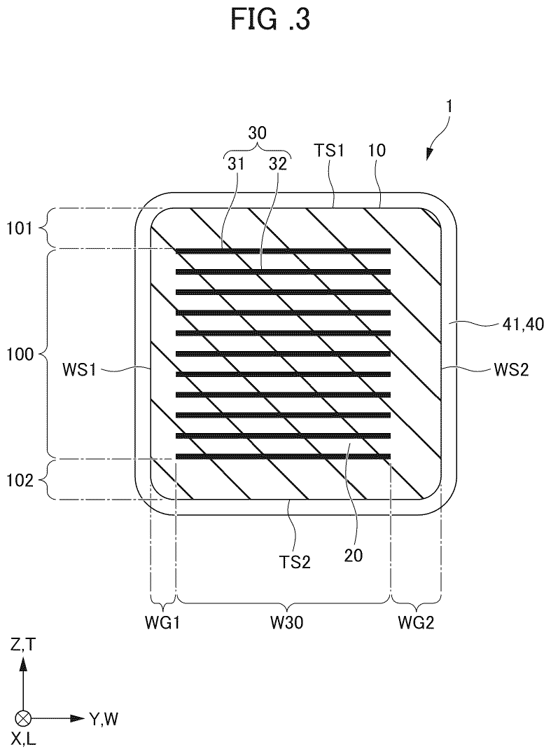

FIG. 1 is a perspective view showing a multilayer ceramic capacitor according to an example embodiment of the present invention. FIG. 2 is a cross-sectional view along the line II-II of the multilayer ceramic capacitor shown in FIG. 1. FIG. 3 is a cross-sectional view along the line III-III of the multilayer ceramic capacitor shown in FIG. 1. The multilayer ceramic capacitor 1 shown in FIGS. 1 to 3 includes a multilayer body 10 and external electrodes 40. The external electrodes 40 include a first external electrode 41 and a second external electrode 42.

FIGS. 1 to 3 show an XYZ Cartesian coordinate system. The X direction refers to the length direction L of the multilayer ceramic capacitor 1 and the multilayer body 10, the Y direction refers to the width direction W of the multilayer ceramic capacitor 1 and the multilayer body 10, and the Z direction refers to the lamination direction T of the multilayer ceramic capacitor 1 and the multilayer body 10. Accordingly, the cross-section shown in FIG. 2 is also referred to as an LT cross-section, and the cross-section shown in FIG. 3 is also referred to as a WT cross-section.

The length direction L, the width direction W, and the lamination direction T are not necessarily orthogonal or substantially orthogonal to each other, and it is sufficient for these directions to intersect with each other.

The multilayer body 10 has a rectangular or substantially rectangular parallelepiped shape, and includes a first main surface TS1 and a second main surface TS2 opposed to each other in the lamination direction T, a first lateral surface WS1 and a second lateral surface WS2 opposed to each other in the width direction W, and a first end surface LS1 and a second end surface LS2 opposed to each other in the length direction L. The surfaces may include unevenness or may be roughened.

It is preferable that the corner portions and ridge portions of the multilayer body 10 are rounded. The corner portions are portions where three surfaces of the multilayer body 10 intersect, and the ridge portions are portions where two surfaces of the multilayer body 10 intersect.

As shown in FIGS. 2 and 3, the multilayer body 10 includes a plurality of dielectric layers 20 and a plurality of internal electrode layers 30 that are laminated in the lamination direction T. The multilayer body 10 also includes, in the lamination direction T, an inner layer portion 100, and a first outer layer portion 101 and a second outer layer portion 102 that sandwich the inner layer portion 100.

The inner layer portion 100 includes a portion of the plurality of dielectric layers 20 and the plurality of internal electrode layers 30. In the inner layer portion 100, the plurality of internal electrode layers 30 are opposed to each other with a corresponding one of the dielectric layers 20 interposed therebetween. The inner layer portion 100 is a portion that generates capacitance and defines and functions substantially as a capacitor.

The first outer layer portion 101 is adjacent to the first main surface TS1 of the multilayer body 10, and the second outer layer portion 102 is adjacent to the second main surface TS2 of the multilayer body 10. More specifically, the first outer layer portion 101 is provided between an internal electrode layer 30 closest to the first main surface TS1 among the plurality of internal electrode layers 30 and the first main surface TS1, and the second outer layer portion 102 is provided between an internal electrode layer 30 closest to the second main surface TS2 among the plurality of internal electrode layers 30, and the second main surface TS2. The first outer layer portion 101 and the second outer layer portion 102 do not include any internal electrode layers 30.

As the material of the dielectric layers 20, for example, a dielectric ceramic including BaTiO₃, CaTio₃, SrTiO₃, or CaZro₃ as a main component can be used. In addition, the material of the dielectric layers 20 may also include, for example, a Mn compound, a Fe compound, a Cr compound, a Co compound, or a Ni compound as a sub-component.

The thickness of the dielectric layers 20 is not particularly limited, but is, for example, preferably about 0.40 μm or more and about 0.50 μm or less, and more preferably about 0.40 μm or more and about 0.45 μm or less. The number of dielectric layers 20 is not particularly limited, but is, for example, preferably 100 or more and 2000 or less. The number of dielectric layers 20 here refers to the total number of dielectric layers in the inner layer portion and dielectric layers in the outer layer portions.

The plurality of internal electrode layers 30 include a plurality of first internal electrode layers 31 and a plurality of second internal electrode layers 32. The plurality of first internal electrode layers 31 and the plurality of second internal electrode layers 32 are alternately provided in the lamination direction T of the multilayer body 10.

Each of the plurality of first internal electrode layers 31 includes a counter electrode portion 311 and an extension electrode portion 312, and each of the plurality of second internal electrode layers 32 includes a counter electrode portion 321 and an extension electrode portion 322.

The counter electrode portion 311 and the counter electrode portion 321 are opposed to each other with a corresponding one of the plurality of dielectric layers 20 interposed therebetween in the lamination direction T of the multilayer body 10. The shapes of the counter electrode portion 311 and the counter electrode portion 321 are not particularly limited, and may be, for example, rectangular or substantially rectangular. The counter electrode portion 311 and the counter electrode portion 321 refer to portions that generate capacitance and define and function substantially as a capacitor.

The extension electrode portion 312 extends from the counter electrode portion 311 toward the first end surface LS1 of the multilayer body 10 and is exposed at the first end surface LS1. The extension electrode portion 322 extends from the counter electrode portion 321 toward the second end surface LS2 of the multilayer body 10 and is exposed at the second end surface LS2. The length in the width direction W of the counter electrode portion 311 and the extension electrode portion 312 may be the same or different. Also, these lengths in the width direction W may gradually change toward the first end surface LS1 where they are exposed. The length in the width direction W of the counter electrode portion 321 and the extension electrode portion 322 may be the same or different. Also, these lengths in the width direction W may gradually change toward the second end surface LS2 where they are exposed.

Thus, each of the first internal electrode layers 31 is connected to the first external electrode 41, and there is a gap between the first internal electrode layer 31 and the second end surface LS2 of the multilayer body 10, that is, the second external electrode 42. Also, each of the second internal electrode layers 32 is connected to the second external electrode 42, and there is a gap between the second internal electrode layer 32 and the first end surface LS1 of the multilayer body 10, that is, the first external electrode 41.

The first internal electrode layers 31 and the second internal electrode layers 32 include, for example, metal Ni as a main component. In addition, the first internal electrode layers 31 and the second internal electrode layers 32 may include, for example, as a main component or as a component other than the main component, at least one selected from metals such as Cu, Ag, Pd, or Au, or alloys including at least one of these metals, such as Ag—Pd alloy. Furthermore, the first internal electrode layers 31 and the second internal electrode layers 32 may includes, for example, particles of a dielectric having the same composition system as the ceramic included in the dielectric layer 20 as a component other than the main component. In this specification, the main component metal indicates the metal component with the highest weight %.

The thickness of the first internal electrode layers 31 and the second internal electrode layers 32 is not particularly limited, but is, for example, preferably about 0.30 μm or more and about 0.40 μm or less, and more preferably about 0.30 μm or more and about 0.35 μm or less. The number of the first internal electrode layers 31 and the second internal electrode layers 32 is not particularly limited, but, for example is preferably 10 or more and 1000 or less.

Methods for measuring the thickness of the dielectric layer 20 and the internal electrode layer 30 include, for example, a method of observing an LT cross section near the middle in the width direction of the multilayer body exposed by polishing, using a scanning electron microscope. Also, each value may be an average value of measurements at multiple locations in the length direction, or may further be an average value of measurements at multiple locations in the lamination direction.

As shown in FIG. 3, the multilayer body 10 includes, in the width direction W, an electrode counter portion W30 where the internal electrode layers 30 are opposed to each other, and a first side gap portion WG1 and a second side gap portion WG2 that sandwich the electrode counter portion W30. The first side gap portion WG1 is located between the electrode counter portion W30 and the first lateral surface WS1, and the second side gap portion WG2 is located between the electrode counter portion W30 and the second lateral surface WS2. More specifically, the first side gap portion WG1 is located between the end of each of the internal electrode layers 30 adjacent to the first lateral surface WS1 and the first lateral surface WS1, and the second side gap portion WG2 is located between the end of each of the internal electrode layers 30 adjacent to the second lateral surface WS2 and the second lateral surface WS2. The first side gap portion WG1 and the second side gap portion WG2 do not include any internal electrode layers 30 and include only the dielectric layers 20. The first side gap portion WG1 and the second side gap portion WG2 are also referred to as W gaps.

Each of the internal electrode layers 30 may include, for example, Si segregation at the end portion in the width direction W adjacent to the first lateral surface WS1, and the bending strength of the multilayer ceramic capacitor 1 is improved due to the presence of Si segregation. The amount of Si segregation in the width direction W adjacent to the second lateral surface WS2 of each of the internal electrode layers 30 may be less compared to the end portion in the width direction W adjacent to the first lateral surface WS1.

As shown in FIG. 2, the multilayer body 10 includes, in the length direction L, an electrode counter portion L30 where the first internal electrode layers 31 and the second internal electrode layers 32 of the internal electrode layer 30 are opposed to each other, a first end gap portion LG1, and a second end gap portion LG2. The first end gap portion LG1 is located between the electrode counter portion L30 and the first end surface LS1, and the second end gap portion LG2 is located between the electrode counter portion L30 and the second end surface LS2. More specifically, the first end gap portion LG1 is located between the end of each of the second internal electrode layers 32 adjacent to the first end surface LS1 and the first end surface LS1, and the second end gap portion LG2 is located between the end of each of the first internal electrode layers 31 adjacent to the second end surface LS2 and the second end surface LS2. The first end gap portion LG1 does not include any second internal electrode layers 32, and includes the first internal electrode layers 31 and the dielectric layers 20, and the second end gap portion LG2 does not include any first internal electrode layers 31, and includes the second internal electrode layers 32 and the dielectric layers 20. The first end gap portion LG1 is a portion that functions as an extension electrode portion of each of the first internal electrode layers 31 toward the first end surface LS1, and the second end gap portion LG2 is a portion that functions as an extension electrode portion of each of the second internal electrode layers 32 toward the second end surface LS2. The first end gap portion LG1 and the second end gap portion LG2 are also referred to as L gaps.

In the electrode counter portion L30, the counter electrode portions 311 of the first internal electrode layers 31 and the counter electrode portions 321 of the second internal electrode layers 32 described above are located. Also, in the first end gap portion LG1, the extension electrode portions 312 of the first internal electrode layers 31 described above are located, and in the second end gap portion LG2, the extension electrode portions 322 of the second internal electrode layers 32 described above are located.

Methods for measuring the thickness of the multilayer body 10 include, for example, a method of observing an LT cross section near the middle in the width direction of the multilayer body exposed by polishing, or a method of observing a WT cross section near the middle in the length direction of the multilayer body exposed by polishing, using a scanning electron microscope. Also, each value may be an average value of measurements at multiple locations in the length direction or width direction. Similarly, methods for measuring the length of the multilayer body 10 include, for example, a method of observing an LT cross section near the middle in the width direction of the multilayer body exposed by polishing using a scanning electron microscope. Also, each value may be an average value of measurements at multiple locations in the lamination direction. Similarly, methods for measuring the width of the multilayer body 10 include, for example, a method of observing a WT cross section near the middle in the length direction of the multilayer body exposed by polishing, using a scanning electron microscope. Also, each value may be an average value of measurements at multiple locations in the lamination direction.

The external electrodes 40 include a first external electrode 41 and a second external electrode 42.

The first external electrode 41 is provided on the first end surface LS1 of the multilayer body 10 and is connected to the first internal electrode layers 31. The first external electrode 41 may extend from the first end surface LS1 toward a portion of the first main surface TS1 and a portion of the second main surface TS2. Also, the first external electrode 41 may extend from the first end surface LS1 toward a portion of the first lateral surface WS1 and a portion of the second lateral surface WS2.

The second external electrode 42 is provided on the second end surface LS2 of the multilayer body 10 and is connected to the second internal electrode layers 32. The second external electrode 42 may extend from the second end surface LS2 toward a portion of the first main surface TS1 and a portion of the second main surface TS2. Also, the second external electrode 42 may extend from the second end surface LS2 toward a portion of the first lateral surface WS1 and a portion of the second lateral surface WS2.

The first external electrode 41 includes a first base electrode layer 415 and a first plated layer 416, and the second external electrode 42 includes a second base electrode layer 425 and a second plated layer 426. The first external electrode 41 may include only the first plated layer 416, or the second external electrode 42 may include only the second plated layer 426.

The first base electrode layer 415 and the second base electrode layer 425 may be, for example, fired layers including metal and glass. Examples of the glass include glass components including at least one of B, Si, Ba, Mg, Al, or Li. As a specific example, borosilicate glass can be used. The metal includes Cu as a main component, for example. The metal may include, as a main component, at least one of a metal such as Ni, Ag, Pd, or Au, and an alloy such as an Ag—Pd alloy, or may include a component other than the main component.

The fired layer is a layer manufactured by applying an electrically conductive paste including metal and glass to the multilayer body by a dipping method, and then firing it. The fired layer may be fired after the firing of the internal electrode layers, or may be co-fired with the internal electrode layers. In addition, the fired layer may include multiple layers.

Alternatively, the first base electrode layer 415 and the second base electrode layer 425 may be, for example, resin layers including electrically conductive particles and thermosetting resin. The resin layer may be provided on the fired layer described above, or may be provided directly on the multilayer body without providing the fired layer.

The resin layer is a layer formed by, for example, applying an electrically conductive paste including electrically conductive particles and thermosetting resin to the multilayer body by a coating method, and then firing it. The resin layer may be fired after the firing of the internal electrode layers, or may be co-fired with the internal electrode layers. In addition, the resin layer may include multiple layers.

The thickness of each layer of the first base electrode layer 415 and the second base electrode layer 425 as the fired layer or resin layer is not particularly limited, and may be, for example, about 1 μm or more and about 10 μm or less.

Alternatively, the first base electrode layer 415 and the second base electrode layer 425 may be thin film layers of, for example, about 1 μm or less which are each formed by a thin film forming method such as sputtering or vapor deposition, and in which metal particles are deposited.

The first plated layer 416 covers at least a portion of the first base electrode layer 415, and the second plated layer 426 covers at least a portion of the second base electrode layer 425. The first plated layer 416 and the second plated layer 426 include, for example, at least one metal such as Cu, Ni, Ag, Pd, or Au, or an alloy such as Ag—Pd alloy.

The first plated layer 416 and the second plated layer 426 may each include multiple layers. Preferably, for example, they include a two-layer configuration of Ni plating and Sn plating. The Ni plated layer can prevent the base electrode layer from being eroded by solder when mounting the ceramic electronic component, and the Sn plated layer can improve the wettability of solder when mounting the ceramic electronic component, thus facilitating mounting. The first plated layer 416 and the second plated layer 426 may each include a three-layer configuration by laminating, for example, Sn plating, Ni plating, and Sn plating. The outermost layer may be, for example, Au plating.

The thickness of each layer of the first plated layer 416 and the second plated layer 426 is not particularly limited, and may be, for example, about 1 μm or more and about 10 μm or less.

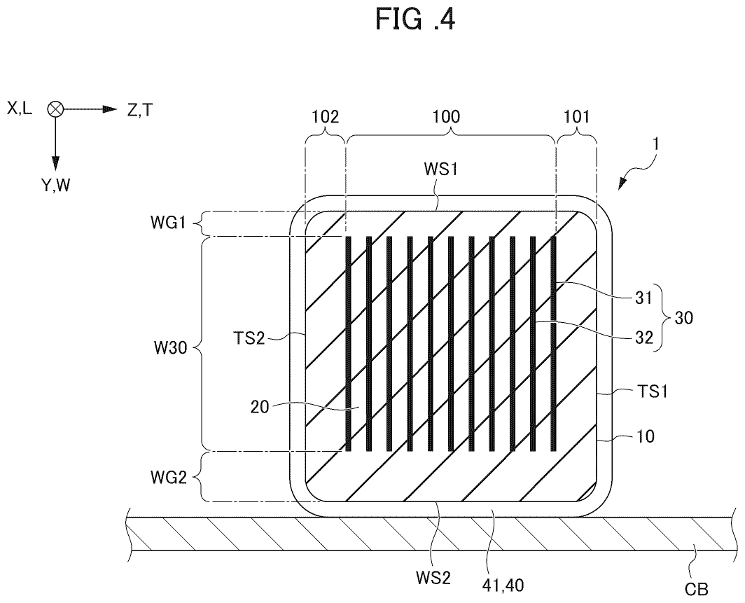

As for the mounting configuration of the multilayer ceramic capacitor 1, as shown in FIG. 4, the multilayer ceramic capacitor 1 is mounted on the circuit board CB such that the second lateral surface WS2 is opposed to the circuit board CB.

### Internal Electrode Layers

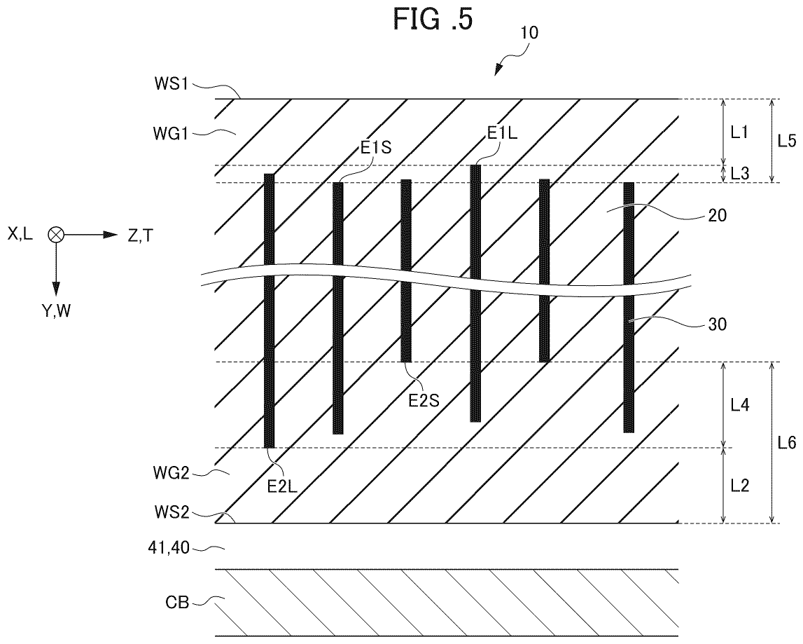

Next, the internal electrode layers 30, that is, the first internal electrode layer 31 and the second internal electrode layer 32, will be further described. FIG. 5 is an enlarged view of the end portions of the internal electrode layers in the multilayer ceramic capacitor shown in FIG. 4, and schematically shows variations in the arrangement of the end portions in the width direction W of the internal electrode layers 30, that is, the first internal electrode layers 31 and the second internal electrode layers 32.

As shown in FIG. 5, the distance L1 between an end portion ELL, which is closest to the first lateral surface WS1 among the end portions of the internal electrode layers 30 provided adjacent to the first lateral surface WS1 in the width direction W, and the first lateral surface WS1 is smaller than the distance L2 between an end portion E2L, which is closest to the second lateral surface WS2 among the end portions of the internal electrode layers 30 provided adjacent to the second lateral surface WS2 in the width direction W, and the second lateral surface WS2. In addition, the maximum distance L3 in the width direction w between the end portions of the internal electrode layers 30 provided adjacent to the first lateral surface WS1 in the width direction W is smaller than the maximum distance L4 in the width direction W between the end portions of the internal electrode layers 30 provided adjacent to the second lateral surface WS2 in the width direction W.

Here, the maximum distance L3 in the width direction W between the end portions of the internal electrode layers 30 provided adjacent to the first lateral surface WS1 in the width direction W corresponds to the distance in the width direction W between the end portion ELL, which is the end portion closest to the first lateral surface WS1 in the width direction W, and the end portion E1S, which is closest to the second lateral surface WS2, among the end portions of the internal electrode layers 30 provided adjacent to the first lateral surface WS1. In addition, the maximum distance L4 in the width direction W between the end portions of the internal electrode layers 30 provided adjacent to the second lateral surface WS2 in the width direction W corresponds to the distance in the width direction W between the end portion E2L, which is the end portion closest to the second lateral surface WS2 in the width direction W, and the end portion E2S, which is closest to the first lateral surface WS1, among the end portions of the internal electrode layers 30 provided adjacent to the second lateral surface WS2.

In the multilayer ceramic capacitor 1 in which the end portions in the width direction W of the internal electrode layers 30 are provided in this manner, by mounting the multilayer ceramic capacitor 1 on a circuit board CB with the second lateral surface WS2 opposed to the circuit board CB, it is possible for a portion that provides a capacitance to be distanced from the mounting surface, thus reducing or preventing the occurrence of “acoustic noise”. This eliminates the need to provide a spacer or a dielectric ceramic layer that provides a space between the internal electrode layers 30 and the circuit board CB in the prior art, making it easy to reduce the size and increase the capacitance of the multilayer ceramic capacitor 1, while reducing or preventing the occurrence of “acoustic noise”.

It is possible for the end portions in the width direction W of the internal electrode layers 30 adjacent to the second lateral surface WS2 to be provided with appropriate offsets in the width direction W at any position in the lamination direction T. For example, when, in the middle of the multilayer body 10 in the lamination direction T, the end portions of the internal electrode layers 30 provided adjacent to the second lateral surface WS2 in the width direction W are offset with respect to the middle in the width direction W, the contact area between adjacent dielectric layers 20 in the lamination direction T increases, such that it is possible to reduce or prevent the occurrence of interlayer peeling and cracks in the middle of the multilayer body 10 in the lamination direction T. In addition, when the end portions provided adjacent to the second lateral surface WS2 in the width direction W of the internal electrode layers 30 that are located above or below the middle of the multilayer body 10 in the lamination direction T are offset with respect to the middle in the width direction w, it is possible to reduce or prevent the infiltration of moisture from the outside and improve the moisture resistance of the multilayer ceramic capacitor 1.

In addition, in the multilayer ceramic capacitor 1, as shown in FIG. 5, the distance L5 between the end portion E1S, which is closest to the second lateral surface WS2 among the end portions of the internal electrode layers 30 provided adjacent to the first lateral surface WS1 in the width direction W, and the first lateral surface WS1 is smaller than the distance L6 between the end portion E2S, which is closest to the first lateral surface WS1 among the end portions of the internal electrode layers 30 provided adjacent to the second lateral surface WS2 in the width direction W, and the second lateral surface WS2. In addition, the maximum distance L3 in the width direction W between the end portions of the internal electrode layers 30 provided adjacent to the first lateral surface WS1 in the width direction W is smaller than the maximum distance L4 in the width direction W between the end portions of the internal electrode layers 30 provided adjacent to the second lateral surface WS2 in the width direction W.

In the multilayer ceramic capacitor 1 in which the end portions in the width direction W of the internal electrode layers 30 are provided in this manner, by mounting the multilayer ceramic capacitor 1 on a circuit board CB with the second lateral surface WS2 opposed to the circuit board CB, it is possible for the portion that generates capacitance to be distanced from the mounting surface, thus reducing or preventing the occurrence of “acoustic noise”. This eliminates the need to provide a spacer or a dielectric ceramic layer for providing a space between the internal electrode layers 30 and the circuit board CB in the prior art, making it easy to reduce the size and increase the capacitance of the multilayer ceramic capacitor 1, while reducing or preventing the occurrence of “acoustic noise”.

The maximum distance L3 in the width direction W between the end portions of the internal electrode layers 30 provided adjacent to the first lateral surface WS1 in the width direction W is, for example. preferably about 10 μm or less. As described above, when the end portions of the internal electrode layers 30 provided adjacent to the first lateral surface WS1 in the width direction W are provided in a relatively aligned manner, it is possible for the internal electrode layers 30 to be positioned close to the first lateral surface WS1, and it is possible for the end portions of the internal electrode layers 30 provided adjacent to the second lateral surface WS2 to be positioned away from the mounting surface. This makes it possible to obtain the advantageous effects of reducing or preventing acoustic noise without reducing the capacitance of the multilayer ceramic capacitor 1.

The position and distance of the end portions in the width direction W of the internal electrode layers 30 can be observed or measured by, for example, the following method.

First, the multilayer ceramic capacitor 1 is polished in the length direction L to expose the WT cross-sections at about ⅓ and about ½ of the length dimension L of the multilayer ceramic capacitor 1. Then, using a VHX5000 available from Keyence Corporation at a magnification that allows observation of the outermost internal electrode layers in the lamination direction T and the end portion in the width direction of each layer in the obtained cross section, the regions between the end portions in the width direction W of the first internal electrode layers 31 and the second internal electrode layers 32 and the lateral surfaces of the multilayer body 10 are observed or measured.

Si is precipitated at the end portions of the internal electrode layers 30, each provided adjacent to the first lateral surface WS1 in the width direction W, and Si is precipitated in the second side gap portion WG2 between the end portion E2L located closest to the second lateral surface WS2 among the end portions of the internal electrode layers 30 provided adjacent to the second lateral surface WS2 in the width direction, and the second lateral surface WS2. Si may also be precipitated at the end portions of the internal electrode layers 30, each provided adjacent to the second lateral surface WS2 in the width direction.

The bending strength of the multilayer ceramic capacitor 1 is improved by the segregation of Si at the end portions of the internal electrode layers 30 in the width direction W. The segregation amount of Si at the end portions of the internal electrode layers 30 provided adjacent to the second lateral surface WS2 in the width direction W may be less than the segregation amount of Si at the end portions of the internal electrode layers 30 provided adjacent to the first lateral surface WS1 in the width direction W.

### Manufacturing Method

Next, an example of a manufacturing method of the above-described multilayer ceramic capacitor 1 will be explained. First, dielectric sheets for manufacturing the dielectric layers 20 and electrically conductive paste for manufacturing the internal electrode layers 30 are prepared. The dielectric sheets and the electrically conductive paste include a binder and a solvent. Known materials can be used for the binder and the solvent.

Next, an internal electrode pattern is formed on the dielectric sheets by printing the electrically conductive paste in a predetermined pattern, for example, on the dielectric sheets. Screen printing or gravure printing can be used as a method for forming the internal electrode pattern.

Next, a predetermined number of dielectric sheets for manufacturing the second outer layer portion 102 on which no internal electrode pattern is printed are laminated. The dielectric sheets for manufacturing the inner layer portion 100 on which internal electrode patterns are printed are sequentially laminated thereon. A predetermined number of dielectric sheets for manufacturing the first outer layer portion 101 on which no internal electrode pattern is printed are laminated thereon. Thus, a multilayer sheet is produced.

Next, the multilayer sheet is pressed in the lamination direction by, example, hydrostatic pressing to produce a multilayer block. Next, the multilayer block is cut to a predetermined size to cut out a multilayer body chip 10T.

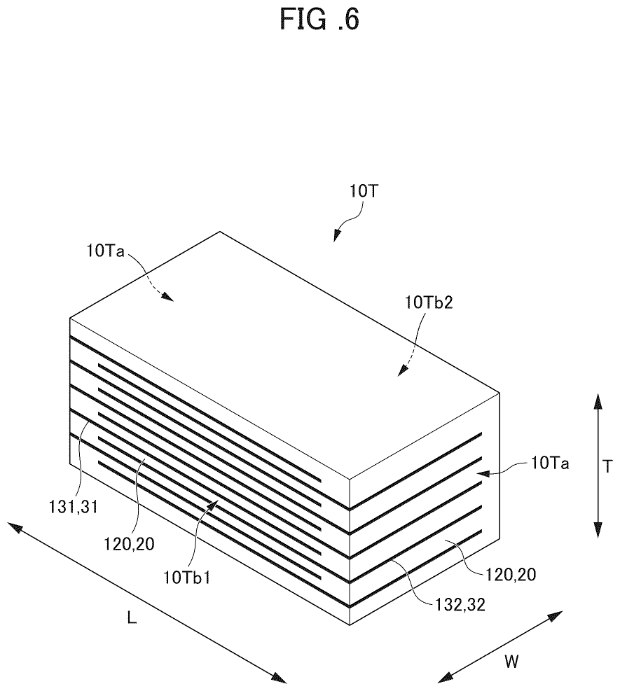

As shown in FIG. 6, the multilayer body chip 10T is formed into a rectangular or substantially rectangular parallelepiped shape as shown in the drawings, by alternately laminating a plurality of material sheets in which electrically conductive patterns 131 that define and function as the first internal electrode layers 31 are printed on the surface of ceramic green sheets 120 for lamination that define and function as the dielectric layers 20, and a plurality of material sheets in which electrically conductive patterns 132 that define and function as the second internal electrode layers 32 are printed, cutting along the lamination direction T, and cutting out.

At a pair of end surfaces 10Ta of the multilayer body chip 10T, the electrically conductive patterns 131 are exposed at one end surface, and the electrically conductive patterns 132 are exposed at the other end surface.

In the first lateral surface 10Tb1 of the multilayer body chip 10T, all of the end portions in the width direction W of the electrically conductive patterns 131 and the electrically conductive patterns 132 that are laminated are provided along the lamination direction T on the exposed first lateral surface 10Tb1 that has been cut out. This makes it possible to provide the end portions of the plurality of internal electrode layers 30 provided adjacent to the first lateral surface WS1 of the multilayer ceramic capacitor 1 in the width direction W to be aligned within a range of, for example, about 10 μm in the width direction W. On the other hand, in the second lateral surface 10Tb2 of the multilayer body chip 10T, the end portions in the width direction W of the electrically conductive patterns 131 and the electrically conductive patterns 132 that are laminated are not cut and are not exposed on the second lateral surface 10Tb2, such that the end portions in the width direction W of the electrically conductive patterns 131 and the electrically conductive patterns 132 are uneven compared to those provided adjacent to the first lateral surface 10Tb1. Therefore, as shown in FIG. 5, the maximum distance L3 in the width direction W between the end portions of the internal electrode layers 30 provided adjacent to the first lateral surface WS1 is smaller than the maximum distance L4 in the width direction W between the end portions of the internal electrode layers 30 provided adjacent to the second lateral surface WS2 in the width direction W.

Covering ceramic green sheets for manufacturing the first side gap portion WG1 and the second side gap portion WG2 are respectively attached to the first lateral surface 10Tb1 and the second lateral surface 10Tb2 of the multilayer body chip 10T to cover them, such that lateral surface covering portions SC are formed. As a result, the end portions in the width direction W of the electrically conductive patterns 131 and the electrically conductive patterns 132 that are exposed on the first lateral surface 10Tb1 of the multilayer body chip 10T described above are covered by one of the lateral surface covering portions SC.

By making the thickness of the covering ceramic green sheets to be attached to the first lateral surface 10Tb1 and the second lateral surface 10Tb2 of the multilayer body chip 10T sufficiently thin, it is possible to reduce the thickness of the first side gap portion WG1 and the second side gap portion WG2.

The distance L1 between the end portion ELL, which is closest to the first lateral surface WS1 among the end portions of the internal electrode layers 30 provided adjacent to the first lateral surface WS1 in the width direction, and the first lateral surface WS1 is, for example, preferably about 5 μm or more and about 40 μm or less, and particularly preferably 5 μm or more and 15 μm or less. With such a configuration, it is possible to increase the distance between the electrode counter portions W30 and the mounting surface, thus reducing or preventing the occurrence of “acoustic noise” without reducing the capacitance.

In the second lateral surface 10Tb2 of the multilayer body chip 10T, since the end portions of the electrically conductive patterns 131 and 132 in the width direction W are not exposed, it is not necessary to protect the end portions, and it is always not necessary to attach the covering ceramic green sheets.

The covering ceramic green sheets may include a composition different from that of the lamination ceramic green sheets 120 that function as the dielectric layers 20, and may have a difference in the concentration of a specific element, or may include multiple regions with different concentrations of a specific element in the covering ceramic green sheets. For example, by making the concentration of Ba included in the lamination ceramic green sheets 120 higher than the concentration of Ba in the covering ceramic green sheets, it is possible to reduce or prevent the penetration of moisture into the inner layer portion 100 of the multilayer ceramic capacitor 1, and particularly, in an example embodiment of the present invention, since the first side gap portion WG1 in the width direction W is thin, this is effective to reduce or prevent moisture penetration and improve reliability.

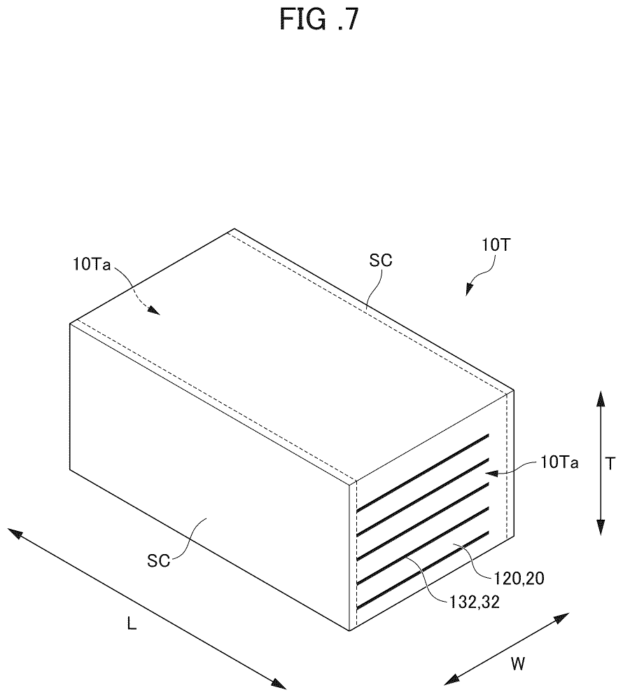

As a result, as shown in FIG. 7, an unfired multilayer body chip 10T with the lateral surface covering portions SC is formed. Next, the unfired multilayer body chip 10T with the lateral surface covering portions SC is fired to produce the multilayer body 10. The firing temperature is, for example, preferably about 900° C. or more and about 1400° C. or less, depending on the materials of the dielectric and the internal electrodes.

Next, for example, using a dipping method, the first end surface LS1 of the multilayer body 10 is immersed in an electrically conductive paste, which is an electrode material for manufacturing the base electrode layer, to apply the electrically conductive paste for manufacturing the first base electrode layer 415 to the first end surface LS1. Similarly, using a dipping method, the second end surface LS2 of the multilayer body 10 is immersed in an electrically conductive paste, which is an electrode material for manufacturing the base electrode layer, to apply the electrically conductive paste for manufacturing the second base electrode layer 425 to the second end surface LS2. Thereafter, these electrically conductive pastes are fired to form the first base electrode layer 415 and the second base electrode layer 425, which are fired layers. The firing temperature is, for example, preferably about 600° C. or more and about 900° C. or less.

As described above, for example, the first base electrode layer 415 and the second base electrode layer 425, which are resin layers, may be formed by applying and firing an electrically conductive paste including electrically conductive particles and a thermosetting resin, or the first base electrode layer 415 and the second base electrode layer 425, which are thin films, may be formed by a thin film formation method such as sputtering or vapor deposition.

Thereafter, the first external electrode 41 is formed by forming the first plated layer 416 on the surface of the first base electrode layer 415, and the second external electrode 42 is formed by forming the second plated layer 426 on the surface of the second base electrode layer 425. The multilayer ceramic capacitor 1 described above is obtained through the above processes.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A multilayer ceramic capacitor comprising:
a multilayer body including a plurality of internal electrode layers alternately laminated in a lamination direction, a first main surface and a second main surface opposed to each other in the lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction; and
a pair of external electrodes each provided at an end in the length direction of the multilayer body so as to cover at least the first end surface and the second end surface, respectively, and each connected to the internal electrode layers; wherein
a distance between an end portion, which is closest to the first lateral surface among end portions of the plurality of internal electrode layers adjacent to the first lateral surface in the width direction, and the first lateral surface is smaller than a distance between an end portion, which is closest to the second lateral surface among end portions of the plurality of internal electrode layers adjacent to the second lateral surface in the width direction, and the second lateral surface; and
a maximum distance in the width direction between the end portions of the plurality of internal electrode layers adjacent to the first lateral surface in the width direction is smaller than a maximum distance in the width direction between the end portions of the plurality of internal electrode layers adjacent to the second lateral surface in the width direction.

2. The multilayer ceramic capacitor according to claim 1, wherein the maximum distance in the width direction between the end portions of the plurality of internal electrode layers adjacent to the first lateral surface in the width direction is about 10 μm or less.

3. The multilayer ceramic capacitor according to claim 1, wherein Si is precipitated on the end portions of the plurality of internal electrode layers adjacent to the first lateral surface in the width direction.

4. The multilayer ceramic capacitor according to claim 1, wherein Si is precipitated between an end portion, which is closest to the second lateral surface among the end portions of the plurality of internal electrode layers adjacent to the second lateral surface in the width direction, and the second lateral surface.

5. The multilayer ceramic capacitor according to claim 1, wherein
each of the plurality of internal electrode layers includes Si segregation at the end portion in the width direction adjacent to the first lateral surface; and
an amount of Si segregation in the width direction adjacent to the second lateral surface of each of the plurality of internal electrode layers is less than an amount of Si segregation at the end portion in the width direction adjacent to the first lateral surface.

6. The multilayer ceramic capacitor according to claim 1, wherein a distance L1 between the end portion, which is closest to the first lateral surface among the end portions of the plurality of internal electrode layers provided adjacent to the first lateral surface in the width direction, and the first lateral surface is about 5 μm or more and about 40 μm or less.

7. The multilayer ceramic capacitor according to claim 2, wherein Si is precipitated on the end portions of the plurality of internal electrode layers adjacent to the first lateral surface in the width direction.

8. The multilayer ceramic capacitor according to claim 2, wherein Si is precipitated between an end portion, which is closest to the second lateral surface among the end portions of the plurality of internal electrode layers adjacent to the second lateral surface in the width direction, and the second lateral surface.

9. The multilayer ceramic capacitor according to claim 6, wherein Si is precipitated on the end portions of the plurality of internal electrode layers adjacent to the first lateral surface in the width direction.

10. The multilayer ceramic capacitor according to claim 6, wherein Si is precipitated between an end portion, which is closest to the second lateral surface among the end portions of the plurality of internal electrode layers adjacent to the second lateral surface in the width direction, and the second lateral surface.

11. A multilayer ceramic capacitor comprising:
a multilayer body including a plurality of internal electrode layers alternately laminated in a lamination direction, a first main surface and a second main surface opposed to each other in the lamination direction, a first lateral surface and a second lateral surface opposed to each other in a width direction orthogonal or substantially orthogonal to the lamination direction, and a first end surface and a second end surface opposed to each other in a length direction orthogonal or substantially orthogonal to the lamination direction and the width direction; and
a pair of external electrodes each provided at an end in the length direction of the multilayer body so as to cover at least the first end surface and the second end surface, respectively, and each connected to the internal electrode layers; wherein
a distance between an end portion, which is closest to the second lateral surface among end portions of the plurality of internal electrode layers adjacent to the first lateral surface in the width direction, and the first lateral surface is smaller than a distance between an end portion, which is closest to the first lateral surface among end portions of the plurality of internal electrode layers adjacent to the second lateral surface in the width direction, and the second lateral surface; and
a maximum distance in the width direction between the end portions of the plurality of internal electrode layers adjacent to the first lateral surface in the width direction is smaller than a maximum distance in the width direction between the end portions of the plurality of internal electrode layers adjacent to the second lateral surface in the width direction.

12. The multilayer ceramic capacitor according to claim 11, wherein the maximum distance in the width direction between the end portions of the plurality of internal electrode layers adjacent to the first lateral surface in the width direction is about 10 μm or less.

13. The multilayer ceramic capacitor according to claim 11, wherein Si is precipitated on the end portions of the plurality of internal electrode layers adjacent to the first lateral surface in the width direction.

14. The multilayer ceramic capacitor according to claim 11, wherein Si is precipitated between an end portion, which is closest to the second lateral surface among the end portions of the plurality of internal electrode layers adjacent to the second lateral surface in the width direction, and the second lateral surface.

15. The multilayer ceramic capacitor according to claim 11, wherein each of the plurality of internal electrode layers includes Si segregation at the end portion in the width direction adjacent to the first lateral surface; and
an amount of Si segregation in the width direction adjacent to the second lateral surface of each of the plurality of internal electrode layers is less than an amount of Si segregation at the end portion in the width direction adjacent to the first lateral surface.

16. The multilayer ceramic capacitor according to claim 11, wherein a distance L1 between the end portion, which is closest to the first lateral surface among the end portions of the plurality of internal electrode layers provided adjacent to the first lateral surface in the width direction, and the first lateral surface is about 5 μm or more and about 40 μm or less.

17. The multilayer ceramic capacitor according to claim 12, wherein Si is precipitated on the end portions of the plurality of internal electrode layers adjacent to the first lateral surface in the width direction.

18. The multilayer ceramic capacitor according to claim 12, wherein Si is precipitated between an end portion, which is closest to the second lateral surface among the end portions of the plurality of internal electrode layers adjacent to the second lateral surface in the width direction, and the second lateral surface.

19. The multilayer ceramic capacitor according to claim 16, wherein Si is precipitated on the end portions of the plurality of internal electrode layers adjacent to the first lateral surface in the width direction.

20. The multilayer ceramic capacitor according to claim 16, wherein Si is precipitated between an end portion, which is closest to the second lateral surface among the end portions of the plurality of internal electrode layers adjacent to the second lateral surface in the width direction, and the second lateral surface.
